(19) United States
(12) Patent Application Publication
(10) Pub. No.: US 2009/0198988 A1
(43) Pub. Date: Aug. 6, 2009

(54) METHOD FOR VERIFYING REFRESHED BIOS CONTENT

(75) Inventors: Yuan Bai, Tianjin (CN); Tom Chen, Taipei (TW); Win-Harn Liu, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/023,570

(22) Filed: Jan. 31, 2008

(51) Int. Cl. G06F 9/00

(52) U.S. Cl. 713/2

(57) ABSTRACT

A method for verifying refreshed BIOS content includes the following steps. A virtual machine (VM) is established in a computer waiting for a system BIOS update by the use of a paravirtualization technique. The VM is booted. A new BIOS file content is copied to an address space in a designated range of a memory of a computer host. The computer host is booted with the content of the new BIOS file, and the paravirtual operating system runs on the same hardware platform of the computer host. And, whether the virtual operating system adopting the new BIOS file content runs normally or not is verified to confirm the correctness and safety of the content of the new BIOS file.

### BACKGROUND OF THE INVENTION

1. Field of Invention

The present invention relates to a method for verifying safety of a file content update in a computer system, and more particularly to a method for verifying refreshed BIOS content, adapted to a safety verification of the update of the BIOS file content of a computer system.

2. Related Art

Currently, in the server management, since the server always needs to be equipped with the latest hardware, the BIOS (basic input output system) capable of identifying the hardware when leaving factory may be impossible to identify and use the latest hardware over a span. Thus, the BIOS of the server must be updated to the latest BIOS version for supporting the identification and usage of the new hardware. However, the refresh of the BIOS faces the risk that if the wrong BIOS file is refreshed, the machine cannot be booted, and even worse, the BIOS chip on the server may be damaged. Meanwhile, it takes a long time to wait for a new release of the BIOS file, such that the cases that the BIOS file is damaged and cannot be booted may often occur.

Therefore, if the BIOS before refreshed is tested on the actual machine and then updated to the electrically erasable programmable read-only memory (EEPROM), the correctness of the refresh operation is ensured, and the possible problems of the server may be reduced. Therefore, a method for verifying refreshed BIOS content is urgently required in this field for solving the problems and defects in the prior art.

### SUMMARY OF THE INVENTION

In order to solve the above problems and defects in the prior art, the present invention is directed to a method for verifying refreshed BIOS content, adapted to a safety verification of a new BIOS file content before the computer BIOS is updated.

The present invention provides a method for verifying refreshed BIOS content, which includes the following steps.

A virtual machine (VM) is established in a computer waiting for a system BIOS update by the use of a paravirtualization technique. The VM is booted. A new BIOS file content is copied to an address space of 1 mega bytes starting from 0000:0000 in a memory of a computer host. The computer host is booted with the content of the new BIOS file, and the paravirtual operating system runs on the same hardware platform of the computer host. And, whether the virtual operating system adopting the new BIOS file content runs normally or not is verified. If normal, the information of normal operation is fed back to a user and the verification is ended, otherwise the information of abnormal operation is fed back to the user and the verification is ended.

In view of the above, the present invention has the following advantages.

In the method for verifying refreshed BIOS content provided by the present invention, the operating system established by the use of a paravirtualization technique runs to realize the safety verification of the new BIOS file content before the computer BIOS is refreshed, so as to avoid the problems in the prior art that if the wrong BIOS file is refreshed into the actual machine, the machine cannot be booted, and even worse, the BIOS chip on the server may be damaged.

### BRIEF DESCRIPTION OF THE DRAWINGS

The present invention will become more fully understood from the detailed description given herein below for illustration only, and thus are not limitative of the present invention, and wherein:

FIG. 1 is a diagram showing a BIOS booting principle according to a method for verifying refreshed BIOS content of the present invention;

FIG. 2 is a diagram showing a principle of a virtualization solution according to the method for verifying refreshed BIOS content of the present invention; and

FIG. 3 is a method flow chart of the method for verifying refreshed BIOS content of the present invention.

### DETAILED DESCRIPTION OF THE INVENTION

Hereinafter, the preferred embodiments of the present invention are illustrated in detail accompanied with the drawings.

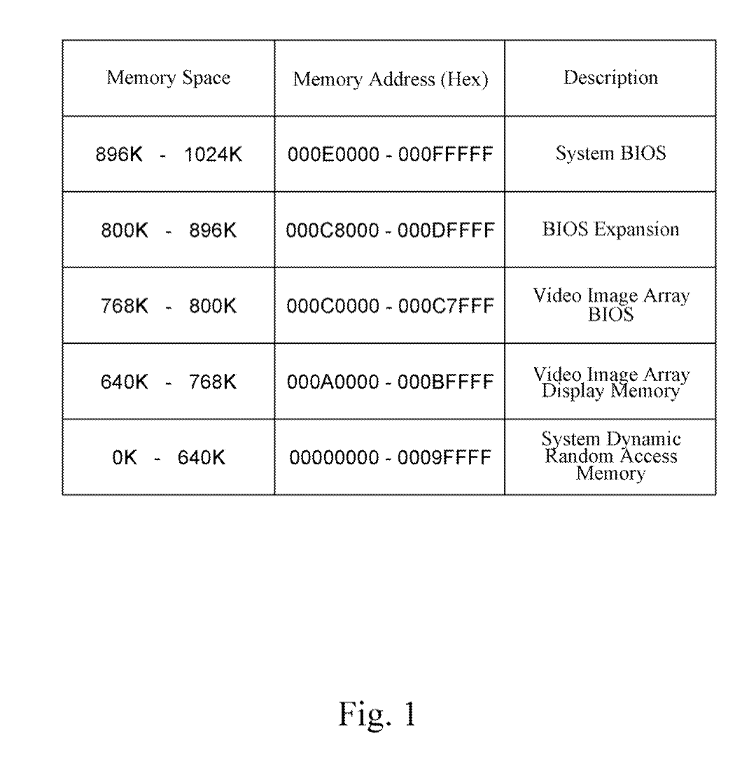

FIG. 1 shows a BIOS booting principle according to a method for verifying refreshed BIOS content in the present invention. As shown in FIG. 1, in a preferred embodiment of the method of the present invention, the computer host (e.g., a server) is powered on (i.e. the power supply is turned on) and then copies the BIOS file to an address space in a designated range in the memory. Then the computer starts executing the codes from an execution start address (usually at 0xFFFF0) in the designated range of the memory. This address is the execution start address of the BIOS, and the content thereof is consistent with the content updated to the BIOS file of the machine. Therefore, the method of the present invention is to copy the content of the new BIOS file to the address space in a designated range in the memory, so as to use the content of the new BIOS file to boot the computer host, thus testing the correctness and safety of the content of the BIOS file for update.

The method for verifying refreshed BIOS content disclosed in the present invention further includes using the virtualization technique to apply the new BIOS content, so as to verify the new BIOS content. Currently, the virtualization technique may be divided into two types, namely full virtualization and paravirtualization. When the full virtualization is used, a level exists between the virtualized operating system and the hardware for deciding the access. The level is referred to as a hypervisor or a virtual machine monitor (VMM). The paravirtualization is similar to the full virtualization, except that the hypervisor operates in a more cooperative way. Since each guest operating system is aware of operating in the virtualization mode, each guest operating system may cooperate with the hypervisor to realize the virtualization of the low level hardware.

In the prior art, examples of full virtualization include a commerce virtualization solution VMware (a computer virtualization software that enables two or more operating systems simultaneously running on one machine), IBM system z9 VM operating system used on commercial IBM z series computers, kernel virtual machine (KVM), and others such as Bochs (a VM software simulating x86 environment), QEMU (an imitated software for imitating in the Windows operating system to form another operating system), VirtualBox (x86 VM software having a powerful function). The example of the paravirtualization includes Xen and User-Mode-Linux (UML). The Xen is a paravirtualized virtual machine monitor (VMM). In order to invoke the hypervisor, the operating system kernel needs to be selectively modified while the application programs running on the operating system remain unchanged. Although other virtualization systems such as VMware realize the full virtualization, that is, the operating system in use will not be modified, it is still necessary to execute the instant machine code translation, which may influence the system performance. The Xen is a special virtual hardware VM having most of the characteristics of the virtual hardware VM and enabling the user to install and test new update software in the existing environment without the worry about the damages to the original system. The User-Mode-Linux (UML) is a safe VM enabling a Linux system running as an independent process on another Linux system. Thus, a plurality of Linux operating systems may be booted on the existing hard disc like the common programs. By using the UML, the user may operate another Linux kernel in a user mode in the Linux system kernel of the computer host, or operate a plurality of independent virtual computers on a single computer.

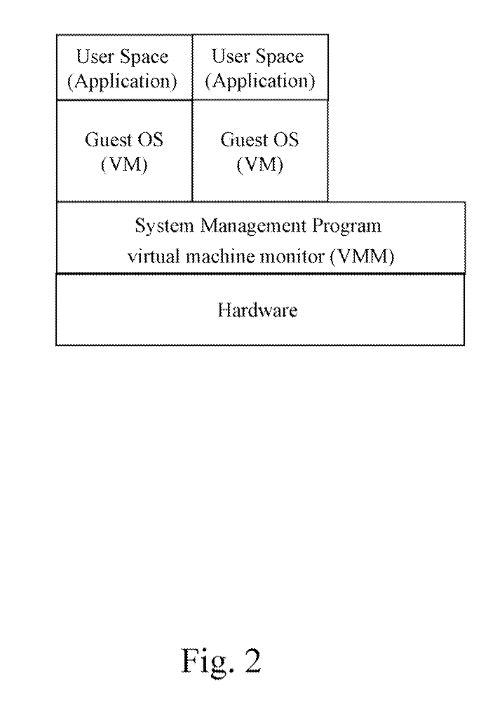

The low level of the virtualization solution is the machine hardware under virtualization. The machine may directly support the virtualization or support the virtualization with the assist of the hypervisor level. The hypervisor, or referred to as virtual machine monitor (VMM), may be considered as the abstraction of the hardware platform and the operating system. In some cases, the hypervisor is an operating system, which then is referred to as a computer host operating system, as shown in FIG. 2.

Above the hypervisor is a guest OS, which is also referred to as a VM and a user space (i.e., application). The VMs are separated operating systems, and consider the hardware platform on the low level as its own. In fact, the hypervisor produces the virtual situation for them.

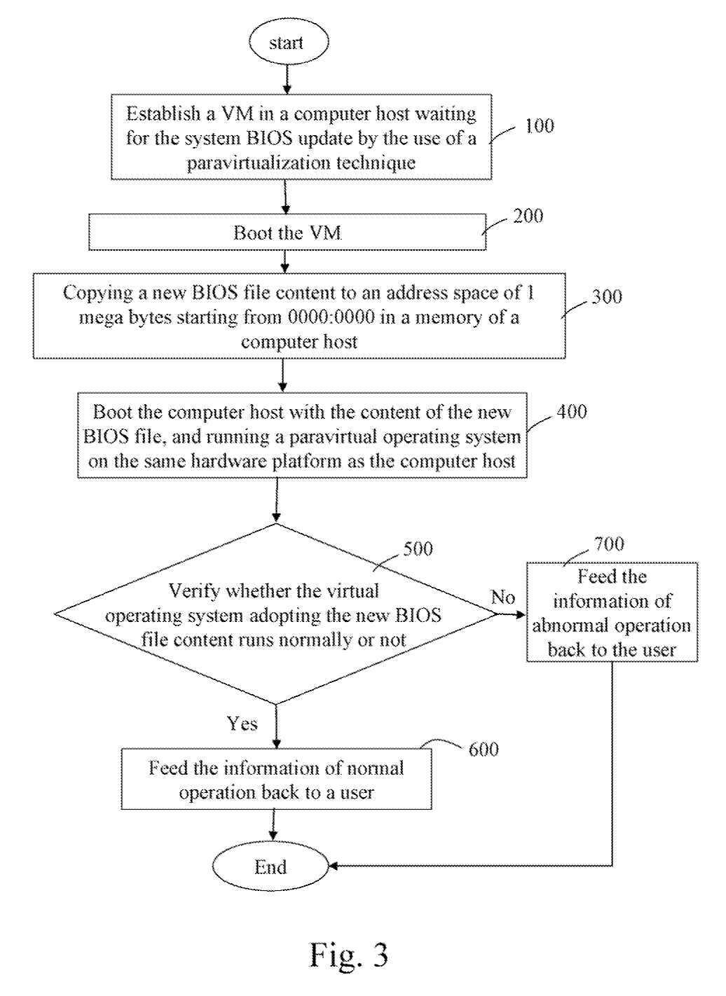

FIG. 3 is a method flow chart of the method for verifying refreshed BIOS content according to the present invention. As shown in FIG. 3, the method for verifying refreshed BIOS content of the present invention includes the following steps.

A VM is established in a computer host waiting for the system BIOS update by the use of a paravirtualization technique (Step 100). The paravirtualization technique is used to establish a VM through the Xen or the UML technology in the prior art. The above VM is booted (Step 200).

A new BIOS file content is copied to an address space of 1 mega bytes starting from 0000:0000 in a memory of the computer host (Step 300).

The computer host is booted with the content of the new BIOS file, and a paravirtual operating system runs on the same hardware platform of the computer host (Step 400).

Whether the virtual operating system adopting the new BIOS file content runs normally or not is verified (Step 500). If normal, the information of normal operation is fed back to a user (Step 600) and the verification is ended, otherwise the information of abnormal operation is fed back to the user (Step 700) and the verification is ended.

What is claimed is:

1. A method for verifying refreshed BIOS content, adapted to a safety verification of a new BIOS file content before the computer BIOS is updated, comprising:
establishing a virtual machine (VM) in a computer host waiting for a system BIOS update by the use of a paravirtualization technique;
booting the VM;
copying a new BIOS file content to an address space of 1 mega bytes starting from 0000:0000 in a memory of the computer host;
booting the computer host with the content of the new BIOS file, and making a paravirtual operating system running on a same hardware platform of the computer host; and
verifying whether the virtual operating system adopting the new BIOS file content runs normally or not, if normal, feeding information of normal operation back to a user and ending the verification, otherwise feeding information of abnormal operation back to the user and ending the verification.

2. The method for verifying refreshed BIOS content according to claim 1, wherein the paravirtualization technique used to establish a VM is a Xen technique.

3. The method for verifying refreshed BIOS content according to claim 1, wherein the paravirtualization technique used to establish a VM is a UML (User-Mode-Linux) technique.
